(19) United States
(12) Patent Application Publication
(10) Pub. No.: US 2006/0286193 A1
(43) Pub. Date: Dec. 21, 2006

(54) Imprint device and microstructure transfer method

(76) Inventors: Takashi Ando, Hitachi (JP); Susumu Komoriya, Tokorozawa (JP); Masahiko Ogino, Hitachi (JP); Chiseki Haginoya, Tokyo (JP); Akihiro Miyauchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/438,336

(22) Filed: May 23, 2006

(30) Foreign Application Priority Data
May 24, 2005 (JP) 2005-151322

(51) Int. Cl. B28B 11/08

(52) U.S. Cl. 425/385

(57) ABSTRACT

In an imprint device and a microstructure transfer method, a fluid is ejected at the back of at least either a stamper or a transfer target body during pressurization of the stamper and the transfer target body. The fluid is ejected through plural holes formed in a stage disposed at the back of at least either the stamper or the transfer target body. The plural holes are connected to independent pressure regulating mechanisms, which can individually control the amount of fluid ejection, the timing of start of ejection, and so on. When the stamper is peeled from the transfer target body, the plural holes are evacuated to fix the stamper or the transfer target body to the stage by suction so as to peel the stamper. The present invention enables to apply uniform pressure to the stamper against the surface of the target substrate, to control the in-plane pressure distribution according to the surface profile or external appearance of the stamper or the target substrate, and to peel the stamper from the target substrate immediately after pressurization.

### BACKGROUND OF THE INVENTION

1. Field of the Invention

The present invention relates to an imprint device and a microstructure transfer method, which are designed to press a stamper having minute recesses and protrusions in and on its surface against a transfer target body, and thereby transfer the recessed and protruding configurations of the stamper to the surface of the transfer target body.

2. Description of the Related Art

Recently, semiconductor integrated circuits have been becoming increasingly minuter and denser, and pattern transfer techniques for realizing microfabrication of the integrated circuits have included improving the accuracy of photolithography equipment. However, the fabrication method has approached the wavelengths of light sources for optical printing, and lithography technique also has been approaching its limits. Thus, an electron beam writer, a type of charged particle beam equipment, has come into use in place of the lithography technique in order to achieve further minuteness and still higher accuracy.

Patterning by using electron beams adopts the approach of writing mask patterns, as distinct from full-wafer printing method for patterning by using a light source such as an i-line or an excimer laser. Thus, more patterns to be written require more time for exposure (or writing). A drawback of such patterning is therefore that the patterning takes a considerable time. Thus, a dramatic rise in the degree of integration to, in turn, 256 megabits, 1 gigabit and 4 gigabits causes a correspondingly dramatic increase in the patterning time, which may lead to a significant impairment in throughput. Thus, the development of full-wafer pattern printing method is proceeding in order to increase the throughput rate of the electron beam writer. Specifically, the method involves irradiating a combination of masks of various shapes with electron beams at a time, thereby yielding electron beams in complicated form. This results in patterns becoming minuter, but it presents a drawback of raising the cost of equipment, such as having to upsize the electron beam writer and also needing a mechanism for controlling mask alignment with higher precision.

As opposed to the above method, there is another imprint technique for achieving minute patterning at low cost. This is the technique of transferring a predetermined pattern, which involves pressing a stamper having recesses and protrusions formed in the same pattern as a desired pattern to be formed on a substrate, against a resist film layer formed on the surface of the substrate targeted for transfer (hereinafter referred to simply as a “target substrate”), thereby embossing the pattern on the substrate, and then peeling the stamper from the substrate. Using a silicon wafer as the stamper, the technique enables transferring a microstructure of 25 nanometers or less, thereby forming the microstructure. Examinations have been made as to applications of the imprint technique to the formation of recording bits of large-capacity recording media, the patterning of semiconductor integrated circuits, and so on.

To transfer a minute pattern to a large-capacity recording medium substrate or a semiconductor integrated circuit substrate with high precision, using the imprint technique, the stamper needs to be pressed against the substrate so as to apply uniform pressure over a pattern transfer region on the target board surface having minute ridges. For example, U.S. Pat. No. 6,696,220 discloses a technique of transferring a minute pattern, which involves mechanically pressing a stamper against a part of the surface of a target substrate. However, an extensive possible transfer region for a single pressing makes the pattern transfer operation more difficult because the surface of the stamper has more difficulty in following the undulation of the surface of the target substrate.

To apply uniform pressure over a large area, Japanese Patent Application Laid-open No. 2003-157520, for example, discloses a technique of rendering applied pressure uniform, which involves interposing a stress buffer layer between a stamper or target substrate and a press head. Also, U.S. Patent Publication No. 2003-0189273 discloses a technique which involves providing a chamber to be filled with a fluid, rather than the stress buffer layer, on the back of a stamper or a target substrate. Moreover, U.S. Pat. No. 6,482,742 discloses a technique which involves disposing a stamper and a target substrate within a vessel capable of regulating its internal pressure; evacuating the vessel; and then filling the vessel with a fluid such as gas, thereby applying uniform pressure throughout the stamper and the target substrate. This technique permits forming a minute pattern on a wafer of up to 200 mm in diameter.

However, the conventional techniques have the problem of being unable to control an in-plane pressure distribution according to the surface profile or external appearance of the stamper or the target substrate. Moreover, the conventional techniques have the problem that a larger stamper is harder to be peeled from the target substrate immediately after pressurization.

### SUMMARY OF THE INVENTION

An object of the present invention is therefore to provide an imprint device and a microstructure transfer method, which enable applying uniform pressure to press a stamper against a surface of a target substrate, also enable controlling an in-plane pressure distribution according to the surface profile or external appearance of the stamper or the target substrate, and also enable peeling the stamper from the target substrate immediately after pressurization.

The imprint device and the microstructure transfer method according to the present invention include ejecting a fluid at the back of at least either the stamper or the transfer target body, when pressurizing the stamper and the transfer target body.

The fluid is ejected through plural holes formed in a stage disposed at the back of at least either the stamper or the transfer target body. Furthermore, the plural holes or grooves are evacuated to make the stamper or the transfer target body adhere to the stage, when the stamper is peeled from the transfer target body.

The imprint device and the microstructure transfer method according to the present invention enable applying uniform pressure to press the stamper against the surface of the target substrate, also enable controlling the in-plane pressure distribution according to the surface profile or external appearance of the stamper or the target substrate, and also enable peeling the stamper from the target substrate immediately after pressurization.

### BRIEF DESCRIPTION OF THE DRAWINGS

FIG. 1 is a schematic sectional view showing a section of a chamber of an imprint device according to the present invention, which presses a transfer target body and a stamper against each other;

FIGS. 2A to 2E are sectional views of assistance in explaining processing steps using an imprint device according to the present invention;

FIG. 3 is a sectional view of assistance in explaining a mechanism for pressurizing and evacuating a chamber of an imprint device according to the present invention;

FIG. 4 is a sectional view of assistance in explaining a parallelism adjustment mechanism of an imprint device according to the present invention;

FIG. 5 is a sectional view of assistance in explaining a mechanism for raising and lowering a stage of an imprint device according to the present invention;

FIGS. 6A to 6C are sectional views of assistance in explaining optical facilities of an imprint device according to the present invention;

FIG. 7 is sectional views and a top view of assistance in explaining a stage mechanism of an imprint device according to the present invention;

FIG. 8 is a plan view of assistance in explaining a layout plan of an imprint device according to the present invention;

FIG. 9 is a sectional view of assistance in explaining mechanisms of an imprint device according to the present invention;

FIG. 10 shows a microscope photograph of a structure formed by the imprint device according to the present invention; and

FIG. 11 shows a microscope photograph of a structure formed by an imprint device according to the present invention.

### DETAILED DESCRIPTION OF THE PREFERRED EMBODIMENT

The plural holes are preferably separated into plural pressure regulating systems. When the plural holes or the plural grooves formed in the surface of the stage and communicating with the plural holes are disposed radially outwardly from the center of the stage, the pressure regulating systems can be controlled to eject the fluid in sequence outwardly from the center during pressurization. Also, when the plural holes or grooves are disposed concentrically or spirally, the pressure regulating systems can be controlled in the same manner. Also, when a pattern is transferred to a substrate having a center hole, such as a substrate for magnetic recording medium, the fluid is not ejected at a position corresponding to the center hole so as not to apply pressure to the position.

Preferably, the pressure regulating system has not only a pressurization mechanism but also an evacuation mechanism. Furthermore, when the pressure regulating system is controlled to perform evacuation in sequence from the outer periphery toward the center during the peeling of the stamper, the stamper is made to adhere to the stage from its outer periphery so that the peeling can be accelerated. Also, when the stamper is peeled from a substrate having a center hole, such as a substrate for magnetic recording medium, pressure is preferably applied only at a position corresponding to the center hole so as to eject the fluid from the substrate side to the stamper through the center hole and thereby to accelerate the peeling.

The pressurization of the stamper and the transfer target body and the peeling of the stamper are preferably performed in one and the same chamber having the function of pressure regulation. The pressurization of the stamper and the transfer target body is preferably performed after the evacuation of the chamber so as to make the stamper and the transfer target body firmly adhere to each other. Also, the peeling of the stamper from the transfer target body is preferably performed after the pressurization of the chamber.

When the stamper is peeled from the transfer target body, a fluid may be admitted into an interface between the stamper and the transfer target body so as to accelerate peeling.

When the stamper is peeled from the transfer target body, a cooled fluid may be ejected from the back of either the stamper or of the transfer target body so as to accelerate peeling by utilizing a difference between linear expansion coefficients of the stamper and the transfer target body.

A stage, from which the fluid is ejected, is disposed at the back of one of the stamper and the transfer target body. Also, a backup plate is disposed at the back of the other thereof, at the back of which the stage is not disposed, and the other is tightly fixed to the backup plate. Thereby, this construction can suppress deformation of the stamper or the transfer target body tightly fixed to the backup plate during pressurization and transfer. Methods for fixing the stamper or the transfer target body to the backup plate include vacuum suction and adhesive bonding.

The stamper or the transfer target body may be fixed at its back to the backup plate with a stress buffer layer laying in between.

When a thickness of the backup plate is greater than a thickness of the stamper or the transfer target body tightly fixed to the backup plate, this construction can prevent deformation of the stamper or the transfer target body tightly fixed to the backup plate during pressurization and transfer. Also, in the present invention, the stamper may be preformed thickly to yield the stamper integral with the backup plate for use.

When a spherical seat and a spherical seat rest are provided at the back of the fluid ejection stage disposed at the back of either the stamper or the transfer target body, the stamper and the transfer target body can be brought into parallelism with each other.

When a movement mechanism, which allows the stage to move in an in-plane direction relative to a transfer surface, is provided at the back of the fluid ejection stage disposed at the back of either the stamper or the transfer target body, this mechanism enables relative alignment of the stamper and the transfer target body.

When an elastic disc guide, which provides vertical movement of the stage relative to the transfer surface, is provided at the back of the fluid ejection stage disposed at the back of either the stamper or the transfer target body, this construction can minimize horizontal misalignment when the stage moves in a vertical direction. Furthermore, when a pressure vessel chamber is provided at the back of the stage and has the function of providing vertical movement of the stage relative to the transfer surface by applying pressure to the chamber, this construction can minimize vibration at the time when the stage moves. Moreover, when a position detector which detects a vertical position of the stage relative to the transfer surface is provided so as to control pressure in the pressure vessel chamber based on the measured values obtained by the detector, this construction enables fine adjustment of a distance between the stamper and the transfer target body.

The stamper for use in the present invention has a minute recessed and protruding pattern to be transferred, and a method of forming the recessed and protruding pattern is not particularly limited. For example, photolithography, ion-beam focusing lithography, electron beam writing method, plating method or the like is selected according to a desired accuracy of fabrication. Silicon, glass, nickel, resins or the like can be used as a material for the stamper. Any material may be used for the stamper, provided that it has strength and required fabricating characteristics.

Preferably, the transfer target body for use in the present invention is made of a material capable of achieving a desired accuracy of microfabrication of a substrate surface, such as a resin thin film coating a substrate, a resin substrate, or a resin sheet. Preferred resin materials include materials consisting mainly of a cycloolefin polymer, polymethyl methacrylate, polystyrene, polycarbonate, polyethylene terephthalate (PET), a polylactic acid, polypropylene, polyethylene, or polyvinyl alcohol. Also included is a synthetic material containing any of these materials and a photosensitive substance added thereto. Also, various materials such as silicon, glass, aluminum alloys or resins can be fabricated to be used for the substrate to be coated with the resin thin film.

Best mode for carrying out the invention will be described below.

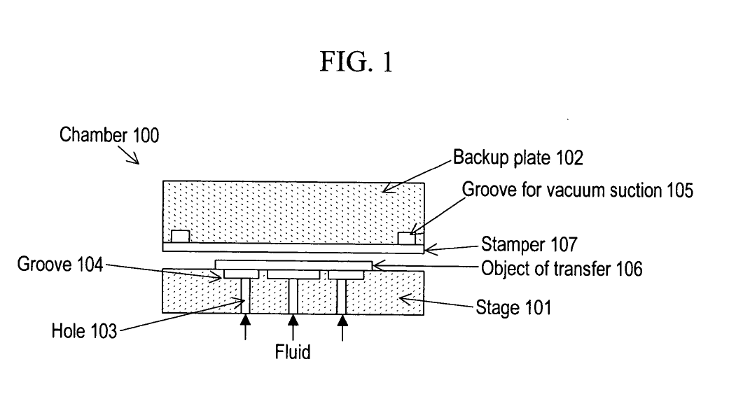

FIG. 1 schematically illustrates a section of a chamber 100 of the present invention. The chamber 100 has a mechanism which peels a stamper from a transfer target body after the application of pressure to the stamper and the transfer target body. The stamper has minute recesses and protrusions. The chamber 100 is set to permit evacuation and pressurization therein. In the bottom stage 101 of the chamber 100, plural holes 103 and grooves 104 are formed. The holes 103 are connected to pressure regulating systems (not shown). The pressure regulating systems each have evacuation and pressurization facilities to permit adhering by vacuum suction and fluid ejection through the holes 103. Provided under the stage 101 is a mechanism which allows the stage 101 to move in horizontal and vertical directions. A backup plate 102 is disposed above the stage 101. In the surface of the backup plate 102, grooves 105 are formed. The grooves 105 serve to fix a stamper 107 (to be described later) by vacuum suction.

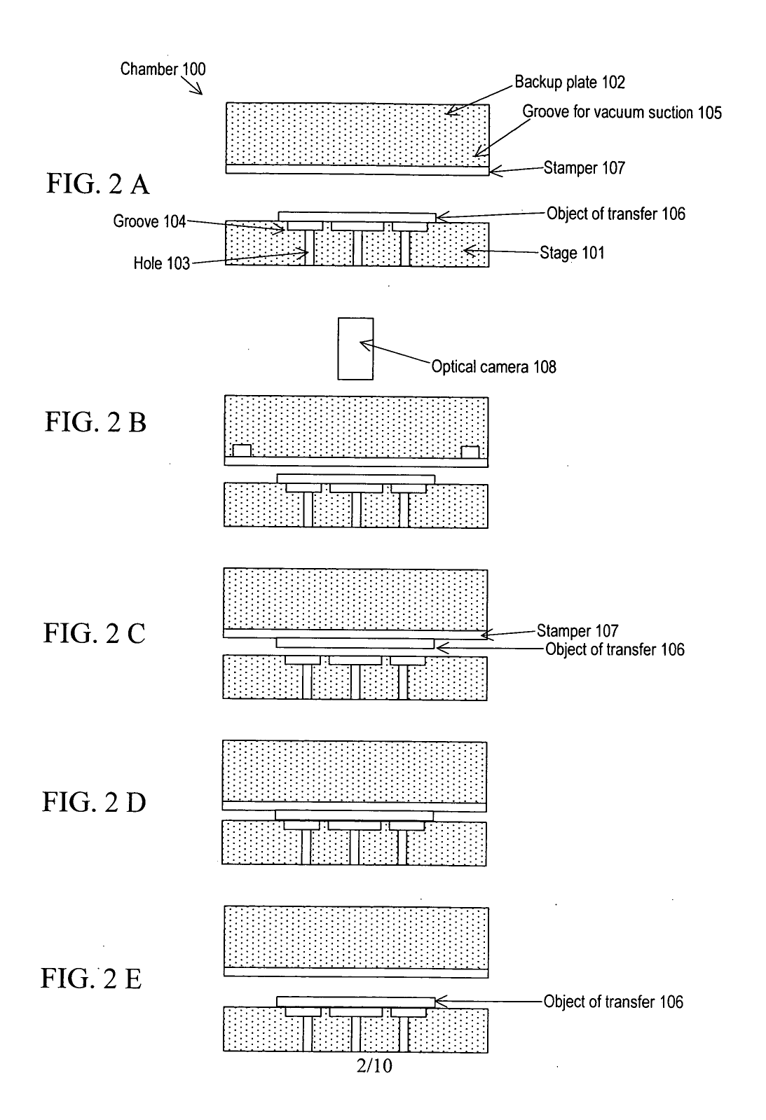

An imprint method according to the present invention will be described with reference to FIGS. 2A to 2E.

The stamper 107 is prepared in advance by forming minute recesses and protrusions in and on the surface of a quartz substrate. An transfer target body 106 is prepared by forming a resin thin film layer having a photosensitive substance added thereto on a silicon substrate. The stamper 107 is fixed to the backup plate 102 by vacuum suction. The transfer target body 106 is mounted on the stage 101 by means of a carrier mechanism (not shown) and is fixed to the stage 101 by vacuum suction (see FIG. 2A).

The tilts of the stage 101 and the backup plate 102 are preadjusted so that a contact surface of the stamper 107 is parallel to that of the transfer target body 106. An optical camera 108 is disposed above the backup plate 102 in order to provide horizontal alignment of the stamper 107 and the transfer target body 106 relative to each other. The stage 101 is raised to such a height that the optical camera 108 can recognize both respective alignment marks preformed on the stamper 107 and the transfer target body 106, and then the stage 101 is horizontally moved so as to align the alignment marks with each other, thereby effecting the alignment (see FIG. 2B).

After the alignment, the chamber 100 is evacuated to such an extent that the stamper 107 and the transfer target body 106 cannot become unfixed. Then, a fluid such as nitrogen is ejected through the holes 103 formed in the stage 101 to thereby tightly press the transfer target body 106 to the stamper 107. At this time, a rear surface of the transfer target body 106 is not in contact with the stage 101. After pressing, an ultraviolet (UV) light irradiation system 215 disposed above the backup plate 102 ejects UV light to effect UV light irradiation to the resin thin film layer, which is formed on the surface of the transfer target body 106 and has the photosensitive substance added thereto, through the backup plate 102 and the stamper 107, thus curing the resin thin film layer (see FIG. 2C).

After the curing of the resin thin film layer, UV light ejection is stopped, and the chamber 100 is pressurized. The stage 101 is brought close to the transfer target body 106 so that the transfer target body 106 adheres to the stage 101 by vacuum suction through the holes 103 formed in the stage 101, and then the stage 101 is lowered to peel the transfer target body 106 from the stamper 107 (see FIG. 2D).

This results in the transfer target body 106, having a pattern transferred thereto (see FIG. 2E). Specifically, the pattern is the minute recessed and protruding pattern formed on the surface of the stamper 107.

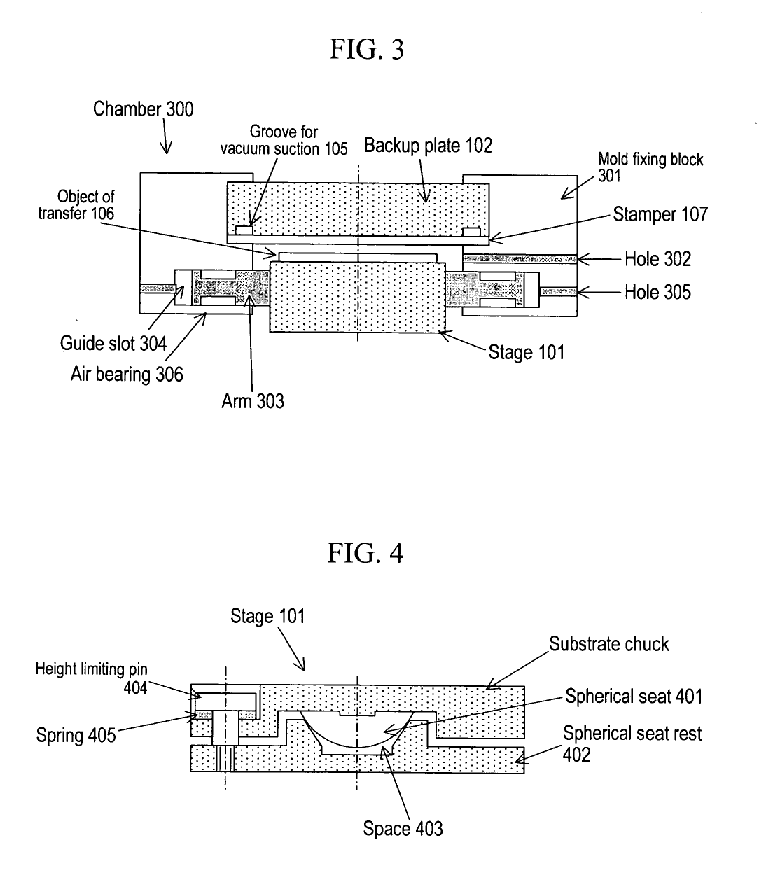

A description will now be given with regard to an example of a mechanism for evacuating and pressurizing the chamber. FIG. 3 shows a section of a chamber 300. The chamber 300 is configured of the backup plate 102 and a mold fixing block 301 in order to provide variable pressure in space in contact with the contact surfaces of the stamper 107 and the transfer target body 106. In a part of the mold fixing block 301, a through hole 302 connected to a pressure regulating mechanism (not shown) is formed. The pressure regulating mechanism evacuates and pressurizes the chamber 300 via the through hole 302.

A description will now be given with reference to FIG. 3 with regard to an example of a mechanism which allows the stage to move in the horizontal direction in order to adjust the relative horizontal positions of the stamper and the transfer target body. The description will be given with regard to movement in the one-dimensional direction (from side to side in FIG. 3) for sake of simplicity. An arm 303 connected to the stage 101 is inserted into a guide slot 304 of the mold fixing block 301. Provided is a so-called air bearing seal mechanism 306 which allows the stage 101 to move in the direction opposite to the pressurized side by the application of pressure to either the right or left guide slot 304 via a through hole 305 connected to a pressure regulating mechanism (not shown). The arm 303 and the guide slot 304 are formed with high precision to create a clearance of 2 to 3 μm between the arm 303 and the guide slot 304, thus permitting smooth movement of the stage 101.

A description will now be given with regard to an example of a parallel adjustment mechanism which serves to render the contact surfaces of the stamper and the transfer target body parallel to each other. FIG. 4 shows a section of the parallel adjustment mechanism. A spherical seat 401 is attached under the stage 101 and is supported on a spherical seat rest 402. At first, space 403 between the spherical seat 401 and the spherical seat rest 402 is under atmospheric pressure, and the stage 101 tilts on the spherical seat rest 402. A height control pin 404 controls the limits of tilt of the stage 101 so as to prevent the stage 101 from tilting extremely. The same substrate as the transfer target body is mounted on the stage 101 in the chamber 300 shown for example in FIG. 3, and the stage 101 and the spherical seat rest 402 are raised together to lightly press the substrate against the stamper, thereby resulting in the surface of the substrate being parallel to that of the stamper. When a vacuum is created in the space 403 under a condition where the substrate remains lightly pressed against the stamper, the spherical seat 401 is tightly fixed to the spherical seat rest 402. The stage 101 and the spherical seat rest 402 are lowered together to thus enable keeping the contact surfaces of the stamper and the transfer target body parallel to each other.

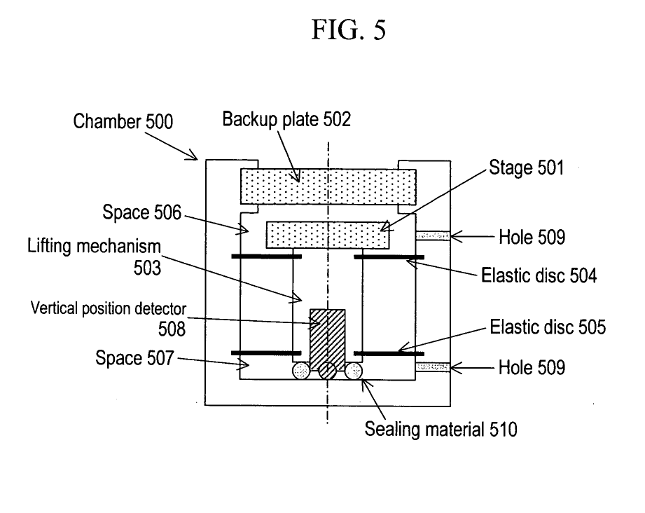

The description will now be given with regard to an example of a mechanism for raising and lowering the stage. FIG. 5 shows a section of the raising and lowering mechanism. A stage 501 and a stage lifting mechanism 503, connected to the bottom of the stage 501, are installed in a chamber 500 capable of pressure regulation. The stage lifting mechanism 503 is provided with a guide mechanism using two parallel elastic discs 504 and 505, thus minimizing horizontal misalignment when the stage moves up and down. The parallel elastic discs 504 and 505 partition the chamber 500 into three spaces. The spaces 506 and 507, respectively partitioned by the upper and lower parallel elastic discs 504 and 505, have connections to independent pressure regulating mechanisms respectively, so that pressures thereof can vary independently. Also, a vertical position detector 508 is installed to recognize a vertical position.

A description will be given below with regard to the principle of operation of the mechanism for raising and lowering the stage. Force Pt is applied to the elastic discs 504 and 505. Specifically, the force Pt is proportional to a differential pressure between respective pressures Pd and Pc in the lower and upper spaces 507 and 506. The force Pt can be expressed in equation form as: Pt=A×(Pd−Pc), where A represents the area of a horizontal plane in space. In other words, the force Pt, proportional to the amount of vertical displacement, is applied to the elastic discs 504 and 505. For example, when an upward displacement force is applied by increasing the pressure in the lower space 507, the stage 501 moves up, and the force Pt becomes larger in proportion to the amount of upward movement. On the other hand, when the stage 501 comes into contact with a backup plate 502, the elastic discs 504 and 505 are subjected to a reaction force produced by the contact of the stage 501 with the backup plate 502. This causes a change in a proportional relationship between the force Pt and the amount of upward movement, thus allowing the vertical position of the contact between the stage 501 and the backup plate 502 to be recognized. The vertical position is detected by the detector 508 and is fed back to control of the pressure regulating mechanisms.

Although the descriptions have been given so far by taking as an example the stage raising and lowering mechanism using the pressure regulating mechanisms, the mechanism may be designed to, for example, mechanically raise and lower the stage.

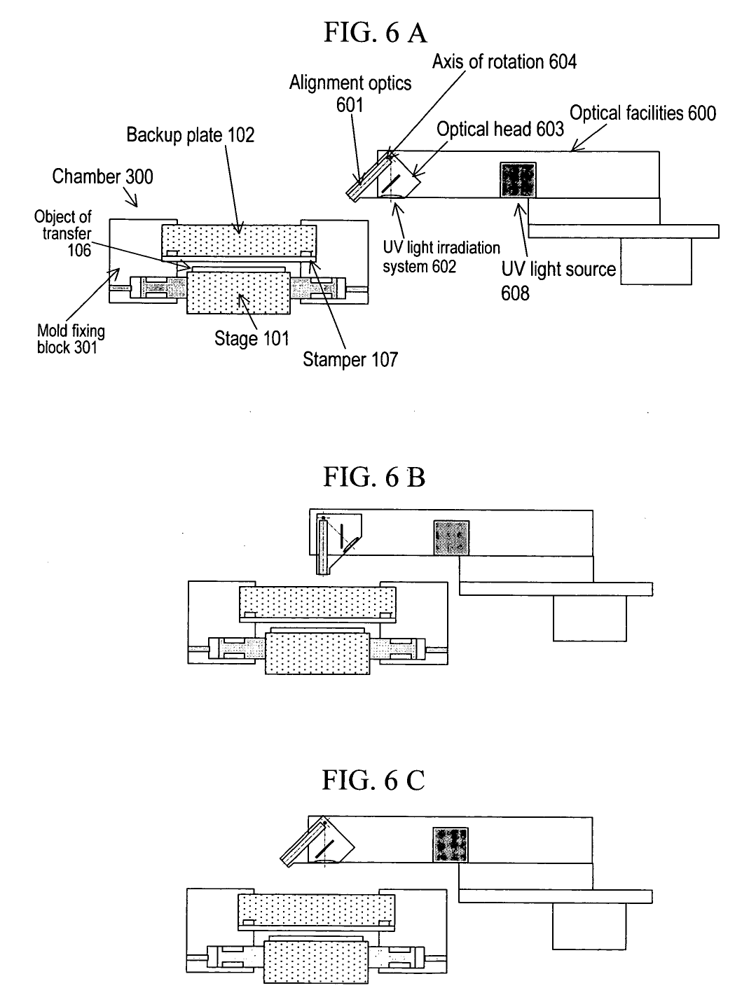

A description will now be given with regard to an example of optical facilities having an alignment facility combined with a UV light irradiation facility. Specifically, the alignment facility is the facility to adjust the relative horizontal positions of the stamper and the transfer target body, and the UV light irradiation facility is the facility to cure the resin thin film layer having the photosensitive substance added thereto. FIGS. 6A to 6C show a section of optical facilities 600 and how the optical facilities 600 operate as viewed along the section. The optical facilities 600 are equipped with a head 603 on an end thereof. The head 603 has alignment optics 601 combined with a UV light irradiation system 602. The head 603 is configured as a mechanism which switches between the alignment optics 601 and the UV light irradiation system 602 about the axis 604 of rotation. In this embodiment of the present invention, a CCD (charge coupled device) camera of up to 1000× magnification is employed as the alignment optics 601 to align the respective alignment marks of the transfer target body and the stamper with each other. The UV light irradiation system 602 includes optics, which are designed so that the system 602 has a maximum irradiation range of 120 mm in diameter. Alignment and UV light irradiation are accomplished by the following steps (1) to (5).

(1) The transfer target body 106 and the stamper 107 are set in the pressurization chamber 300. At this step, the optical facilities 600 are shunted to a predetermined position (see FIG. 6A).

(2) The optical facilities 600 are moved to a position at which alignment is achieved. The mechanism that moves in the horizontal direction, as previously mentioned, is utilized to provide relative alignment of the transfer target body 106 and the stamper 107 (see FIG. 6B).

(3) The head 603 of the optical facilities 600 is switched to the UV light irradiation system 602 to irradiate the UV light onto the surface of the transfer target body 106 through the stamper 107 (see FIG. 6C).

(4) After UV irradiation, the optical facilities 600 are shunted to the predetermined position.

(5) The transfer target body 106 is removed from the pressurization chamber 300.

Although the description is given by taking a resin thin film layer having the photosensitive substance added thereto as an example of the transfer target body, a thin film layer made of a thermoplastic resin may be used. In this case, the UV light irradiation system 602 is not necessary.

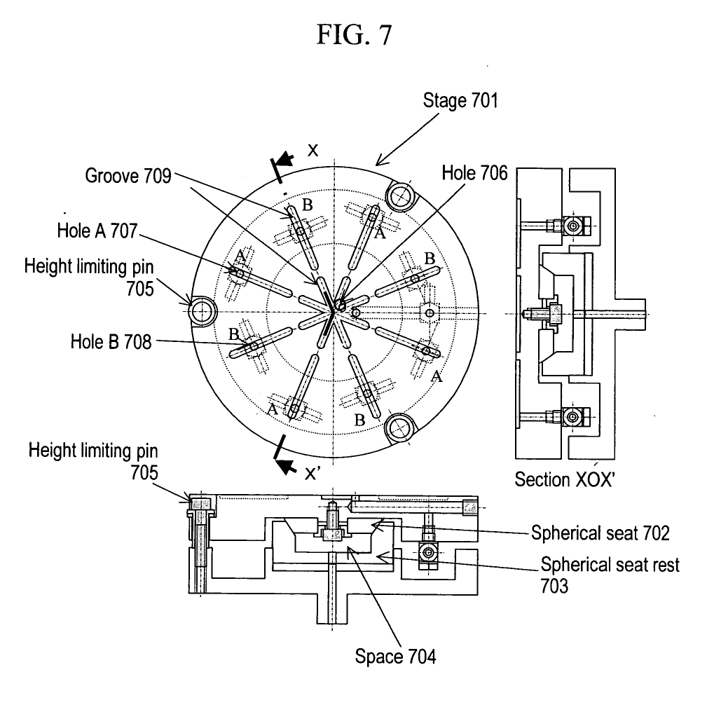

Next, a description will be given with regard to an example of a mechanism of the stage capable of fixing the transfer target body to the stage by suction; of ejecting a fluid to apply pressure to the stamper and the transfer target body; and peeling the stamper. FIG. 7 shows sections and top of the stage. As previously mentioned, a spherical seat 702 and a spherical seat rest 703 are disposed under a stage 701, thus yielding a structure which facilitates making parallelism adjustment to the stamper and the transfer target body. Also, atmospheric pressure can be variable in space 704 between the spherical seat 702 and the spherical seat rest 703. Thus, the space 704 is under pressure during the parallelism adjustment, and after the parallelism adjustment the space 704 is evacuated to fix the tilt of the stage 701. Tilt limiting mechanisms, each of which is configured of a height limiting pin 705 and a spring, are disposed on the stage 701 in its three directions, thus limiting an excessive tilt of the stage 701 and also preventing separation between the spherical seat 702 and the spherical seat rest 703. Holes 706, 707 and 708 formed in the surface of the stage 701 are separated into three independent pressure control mechanisms at the center (706), on the outer peripheries A (707) and on the outer peripheries B (708), respectively. Grooves 709 communicating with the fluid ejection holes are disposed in the surface of the stage 701 and extend radially outwardly from the center of the stage 701.

During the application of pressure to the transfer target body and the stamper, pressure control is performed through the following procedure (1) to (4) to thereby permit pressing out the flow of a resist layer and trace gases originating from the resist, from the center of the transfer target body to the periphery thereof. In the present invention, nitrogen is used as gas to be ejected during the application of pressure.

(1) The holes 706, 707 and 708 disposed at the center, on the outer peripheries A and on the outer peripheries B, respectively, are evacuated to fix the rear surface of the transfer target body to the stage 701 by suction.

(2) The center hole 706 is pressurized to eject the nitrogen gas and thereby apply pressure to the center of the transfer target body.

(3) The holes 707 on the outer peripheries A are pressurized to eject the nitrogen gas and thereby apply pressure around the outer peripheries A.

(4) The holes 708 on the outer peripheries B are pressurized to eject the nitrogen gas and thereby apply pressure around the outer peripheries B.

As a result, the transfer target body is pressurized throughout its entire area. Desirably, the pressure applied to the center hole 706 is set higher than the pressure applied to other holes. The pressure near the holes and grooves for fluid ejection is not high as compared to the pressure in regions with no grooves, but there is, as a whole, a radial distribution of pressure extending from the center to the periphery. This permits pressing out the flow of the resist layer and the trace gases originating from the resist from the center of the transfer target body to the periphery thereof, thus achieving ideal pressurization. When the transfer target body, as pressurized, is cured by irradiation with the UV light, the minute recesses and protrusions of the stamper are formed in and on the surface of the transfer target body.

During the peeling of the stamper, performed after the application of pressure to the transfer target body and the stamper, pressure control is performed through the following processes (1) to (4).

(1) Atmospheric pressure is applied around the stamper and the transfer target body as pressurized.

(2) The holes 708 on the outer peripheries B are evacuated to attract the transfer target body toward the stage 701 near the outer peripheries B.

(3) The holes 707 on the outer peripheries A are evacuated to attract the transfer target body toward the stage 701 near the outer peripheries B and A.

(4) The center hole 706 is evacuated to attract the overall transfer target body toward the stage 701. Thus, the peeling of the stamper is completed.

When the stamper is peeled from the transfer target body, a fluid may be fed into the interface between the stamper and the transfer target body so as to accelerate the peeling.

When the stamper is peeled from the transfer target body, a cooled fluid may be fed at the back of either the stamper or the transfer target body so as to accelerate the peeling by utilizing a difference between the linear expansion coefficients of the stamper and the transfer target body.

The description of the embodiment gives an instance where the fluid is ejected at the back of the transfer target body to apply pressure to the stamper. However, the fluid may be ejected at the back of the stamper to apply pressure to the transfer target body. Alternatively, the fluid may be ejected at the back of both the transfer target body and the stamper.

### EXAMPLES

Examples of the present invention will be described below.

### Example 1

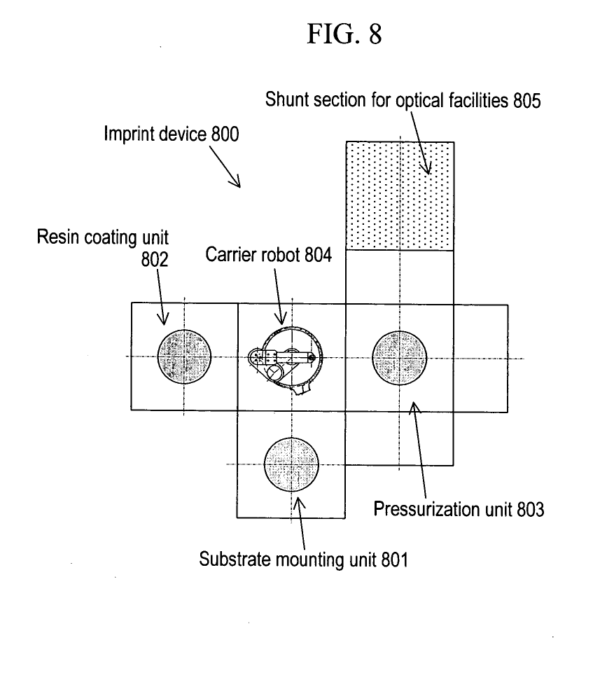

The example 1 will be described with reference to a layout plan view of an imprint device 800 shown in FIG. 8. The device of the invention was configured of three units 801, 802 and 803: 1) the substrate mounting unit 801 designed to mount a substrate to form a transfer target body, and demount the imprinted transfer target body; 2) the resin coating unit 802 designed to prepare the transfer target body by coating the substrate with a resin having a photosensitive substance added thereto; and 3) the pressurization unit 803 designed to provide relative alignment of the transfer target body and a stamper, apply pressure to the transfer target body and the stamper, and peel the stamper from the transfer target body. The transfer target body was transported from one unit to another by means of a carrier robot 804. Besides the three units, there was provided a shunt section 805 for optical facilities having an alignment facility combined with a UV light irradiation facility. Specifically, the alignment facility is the facility to adjust the relative horizontal positions of the stamper and the transfer target body, and the UV light irradiation facility is the facility to cure a resin thin film layer having the photosensitive substance added thereto.

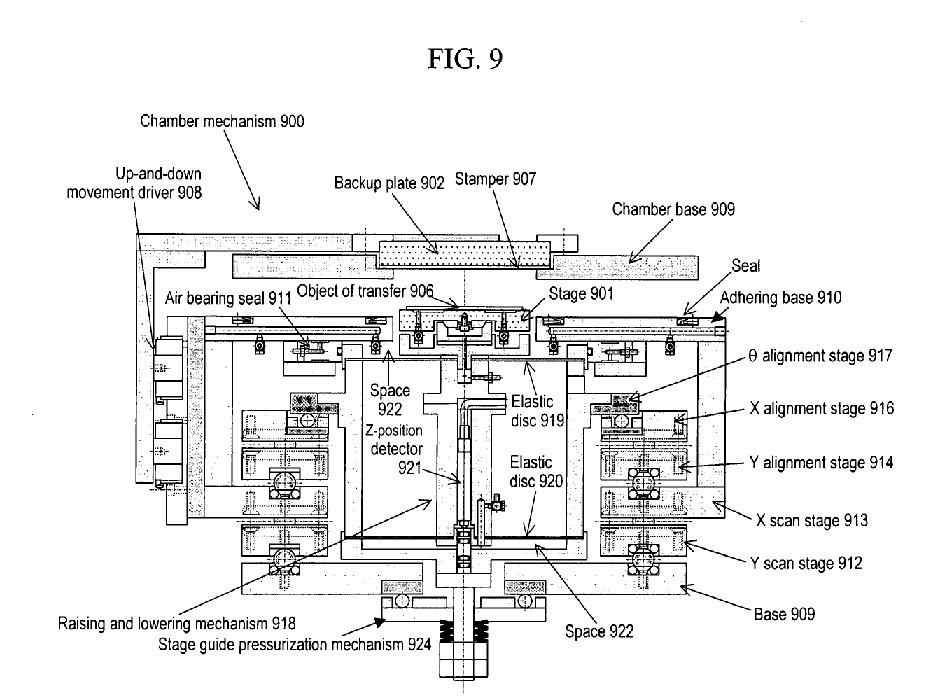

A description will now be given with reference to FIG. 9 with regard to a mechanism of a chamber 900 which performs pressurization and peeling on the transfer target body and the stamper set in the pressurization unit 803. Incidentally, a stage 901 is provided with the horizontal movement mechanism (see FIG. 3), the parallel adjustment mechanism (see FIG. 4), the raising and lowering mechanism (see FIG. 5), and the mechanism for fixing the transfer target body by suction and the fluid ejection mechanism (see FIGS. 6A to 6C) as previously described. The detailed description of the principles of these mechanisms is therefore omitted.

An transfer target body 906 was fixed to the stage 901 by vacuum suction. The transfer target body, as employed in the example 1, was prepared by forming a resin layer of 500 nm thickness having a photosensitive substance added thereto on the surface of a silicon substrate of 100 mm diameter and 0.6 mm thickness. A stamper 907 was fixed by vacuum suction to a backup plate 902 of 15 mm thickness made of quartz. The stamper, as employed in the example 1, was prepared by forming minute recesses and protrusions in and on the surface of a quartz substrate of 100 mm diameter and 1 mm thick. The transfer target body 906 and the stamper 907 were set, and then a chamber base up-and-down movement driver 908 was used to lower a chamber base 909 and thereby fix the chamber base 909 to an adhering base 910 by vacuum suction. Under this condition, the transfer target body 906 and the stamper 907 were sealed on their peripheral pressure surfaces in the chamber 900.

The chamber 900 was provided with an air bearing seal 911 capable of moving in the horizontal (X, Y, θ) direction. Formed was a movement mechanism for high-precision alignment in connection with X, Y and θ alignment stages to be described later.

A Y-direction scan stage 912 was disposed on the base 909 of the chamber 900 in order to move the transfer target body 906 and the stamper 907 in combination to a measurable range of alignment optics. The Y-direction scan stage 912 was configured of a guide mechanism using a needle roller and a steel ball, and a pulse control drive mechanism (not shown). The Y-direction scan stage 912 had an operating range of 100 mm, and its movement was controllable in steps of 0.5 mm. An X scan stage 913 configured in the same manner as the Y scan stage 912 was disposed on the Y scan stage 912.

A Y alignment stage 914 was disposed on the X scan stage 913 and was designed to move the stage 901 alone in order to provide relative alignment of the transfer target body 906 and the stamper 907. The Y alignment stage 914 was configured of a guide mechanism using a needle roller and a steel ball and a pulse control drive mechanism (not shown). The Y alignment stage 914 was configured as the movement mechanism for high-precision alignment, which has an operating range of 5 mm in the X and Y directions and whose movement is controllable in steps of 0.1 μm. An X alignment stage 916 configured in the same manner as the Y alignment stage 914 was disposed on the Y alignment stage 914. A 0 alignment stage 917 was disposed on the X alignment stage 916. The θ alignment stage 917 was configured of a guide mechanism using a three point contact bearing and a steel ball and a pulse control drive mechanism (not shown), thus effecting rotational movement of the stage 901 in a θ direction.

The θ alignment stage 917 had a connection to a raising and lowering mechanism 918 which moves the stage 901 in the vertical (Z) direction. As described with reference to FIG. 5, the raising and lowering mechanism 918 was provided with elastic disc guides 919 and 920, and a Z-position detector 921 was used to perform feedback control of Z position. Independent pressure regulating mechanisms were respectively connected to upper and lower spaces 922 and 923 partitioned by the upper and lower elastic disc guides 919 and 920, respectively. This mechanism had an operating range of 10 mm.

A stage guide pressurization mechanism 924 was disposed in order to prevent a collapse of the chamber 900 due to levitation of the X and Y scan stages 913 and 912, the X, Y and θ alignment stages 916, 914 and 917 and the raising and lowering mechanism 918. The mechanism 924 had a connection to the raising and lowering mechanism 918, and prevented the collapse of the chamber 900 by an elastic body pulling the chamber 900 by a given force in a downward direction.

Pressurization and peeling were performed on the transfer target body 906 and the stamper 907 in the chamber 900 through the following processes (1) to (12).

(1) The transfer target body 906 and the stamper 907 were set, and then the chamber base up-and-down movement driver 908 was used to lower the chamber base 909 and thereby fix the chamber base 909 to the adhering base 910 through vacuum suction.

(2) Optical facilities 930 having the alignment facility combined with the UV light irradiation facility to cure the resin thin film layer having the photosensitive substance added thereto were moved from the shunt section 805 to the pressurization unit 803.

(3) The X and Y scan stages 913 and 912 were positioned so that the center of the optics of the alignment facility might coincide with the center of an alignment reference mark of the stamper 907.

(4) The upper and lower spaces 922 and 923 partitioned by the upper and lower elastic disc guides 919 and 920, respectively, were evacuated.

(5) The lower space 923 partitioned by the lower elastic disc guide 920 was pressurized for the raising and lowering mechanism 918 to raise the transfer target body 906 on the stage 901 toward the stamper 907, in order that the stage 901 might reach such a position that the alignment optics incorporated in the optical facilities could observe both the respective alignment marks preformed on the transfer target body 906 and the stamper 907.

(6) The alignment optics incorporated in the optical facilities and an image signal processing apparatus (not shown) were used to detect the relative positions of the transfer target body 906 and the stamper 907. The X, Y and θ alignment stages 916, 914 and 917 were driven to provide alignment of the transfer target body 906 and the stamper 907, based on the detected relative positions.

(7) The lower space 923 partitioned by the lower elastic disc guide 920 was further pressurized. Thus the raising and lowering mechanism 918 raised the transfer target body 906 on the stage 901 toward the stamper 907. Thereby, the stage 901 moved up to such a predetermined position that a transfer surface of the transfer target body 906 might be in close proximity to the stamper 907. At this step, the alignment optics were used to perform detection and position correction so as to prevent the occurrence of horizontal misalignment of the transfer target body 906 and the stamper 907 relative to each other, incident to upward movement of the stage 901.

(8) The transfer target body 906 was pressed against the stamper 907 under a load of 5 kg/cm² by means of a pressurization method utilizing the mechanism for fixing the transfer target body by suction and the fluid ejection mechanism as previously described with reference to FIGS. 6A to 6C.

(9) The alignment optics of the optical facilities were switched to the UV light irradiation system to irradiate the resin layer on the surface of the transfer target body 906 with UV light through the backup plate 902 and the stamper 907, thereby curing the resin layer.

(10) Pressure in the upper space 922 partitioned by the upper elastic disc guide 919 was returned to atmospheric pressure. The transfer target body 906 was peeled from the stamper 907 by means of a peeling method utilizing the mechanism for fixing the transfer target body by suction and the fluid ejection mechanism as previously described with reference to FIGS. 6A to 6C.

(11) The chamber base 909, which had been fixed to the adhering base 910 by vacuum suction, was unfixed from the adhering base 910. The chamber base 909 was moved upward to open the chamber 900.

(12) The transfer target body 906 was transported to the substrate mounting unit 801 by means of the carrier robot 804. The above procedure resulted in the transfer target body 906 with the surface having the recessed and protruding configurations of the stamper 907 transferred thereto.

### Example 2

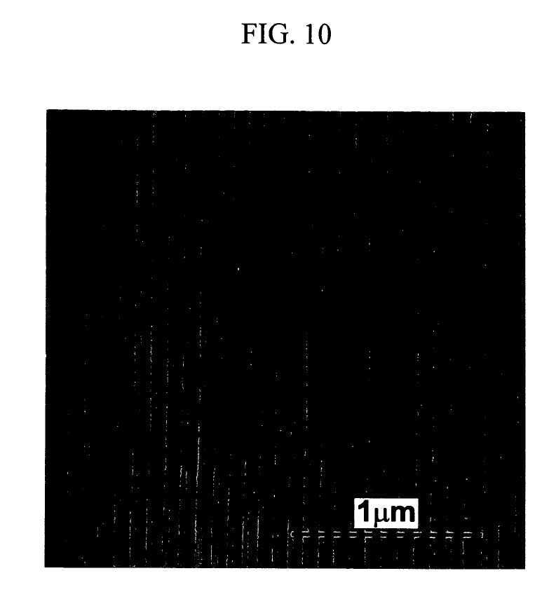

A transfer target body having minute recessed and protruding configurations formed therein was fabricated in the same way as the example 1. In the example 2, what was used as a stamper was a quartz substrate of 100 mm diameter and 1 mm thickness, the whole surfice of which is formed with grooves, each having a width of 50 nm, a depth of 100 nm and a pitch of 100 nm, by using a well-known electron beam (EB) direct writing method. What was used as a transfer target body was a silicon substrate of 100 mm diameter and 0.6 mm thickness, the surface of which is coated with a resin layer of 100 nm thickness having a photosensitive substance added thereto. The use of the stamper and the transfer target body, as mentioned above, yielded a transfer target body having a line structure formed on its surface, the line structure being formed of lines each having a width of 50 nm, a height of 100 nm and a pitch of 100 nm. Shown in FIG. 10 is a SEM (scanning electron microscope) photograph of the recessed and protruding configurations formed in the example 2.

### Example 3

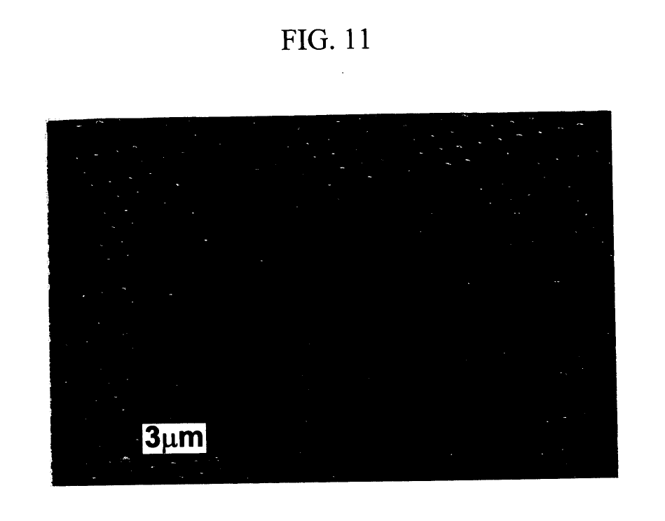

A transfer target body having minute recessed and protruding configurations formed therein was fabricated in the same way as the example 2. In the example 3, what was used as a stamper was prepared using a well-known photolithography technique to form pits, each having a diameter of 0.18 μm, a depth of 1 μm and a pitch of 360 nm, throughout the whole surface of a quartz substrate of 100 mm diameter and 1 mm thickness. What was used as a transfer target body was prepared by forming a resin layer of 500 nm thickness having a photosensitive substance added thereto on the surface of a silicon substrate of 100 mm diameter and 0.6 mm thickness. The use of the stamper and the transfer target body, as mentioned above, yielded the transfer target body having a columnar structure formed on its surface, the columnar structure being formed of columns each having a diameter of 0.18 μm, a height of 1 μm and a pitch of 360 nm. Shown in FIG. 11 is a SEM photograph of the recessed and protruding configurations formed in the example 3.

### Example 4

A transfer target body having minute recessed and protruding configurations formed therein was fabricated in the same way as the example 3. In the example 4, what was used as a stamper was prepared using a well-known electron beam direct writing method to concentrically form grooves, each having a width of 50 nm, a depth of 100 nm and a pitch of 100 nm, throughout the whole surface of a quartz substrate of 100 mm diameter and 1 mm thickness. What was used as the transfer target body was prepared by forming a resin layer of 100 nm thickness having a photosensitive substance added thereto on the surface of a glass substrate having an outer diameter of 65 mm, a center hole diameter of 20 mm and a thickness of 0.635 mm. The arrangement of holes and grooves in the surface of the stage and the control of the ejection and pressurization mechanisms were performed so that a fluid might be ejected only at the back of the transfer target body. The use of the stamper and the transfer target body, as mentioned above, yielded the transfer target body having a concentric line structure formed on its surface, the line structure being formed of lines each having a width of 50 nm, a height of 100 nm and a pitch of 100 nm.

The imprint device and the microstructure forming method according to the present invention are very effective for use in an apparatus and method for manufacturing a sophisticated device requiring an ultra-microstructure, such as recording bits of large-capacity recording media and semiconductor integrated circuit patterns.

What is claimed is:

1. An imprint device which presses a stamper having minute recesses and protrusions and a transfer target body against each other, and thereby transfers recessed and protruding configurations of the stamper to a surface of the transfer target body, the device comprising:
a pressurization mechanism which ejects a fluid through a plurality of holes formed in a stage disposed at the back of at least any one of the stamper and the transfer target body, thereby applying pressure to a rear surface of at least either the stamper or the transfer target body; and
a chamber having a mechanism which peels the stamper.

2. The imprint device according to claim 1, wherein the plurality of holes are connected to a plurality of pressure regulating systems, and the plurality of pressure regulating systems are capable of individually setting respective pressure.

3. The imprint device according to claim 2, wherein each of the plurality of pressure regulating systems has a pressurization and evacuation mechanism, and the pressure regulating systems perform fluid ejection when pressurizing the stamper and the transfer target body, and perform evacuation to make the stamper or the transfer target body adhere to the stage by suction when peeling the stamper from the transfer target body.

4. The imprint device according to claim 1, wherein the plurality of holes communicate with a plurality of grooves formed in a surface of the stage, and the plurality of grooves are disposed radially outwardly from the center of the stage, concentrically or spirally.

5. The imprint device according to claim 1, comprising a pressure regulating system which performs pressurization in sequence outwardly from the center when pressurizing the stamper and the transfer target body.

6. The imprint device according to claim 1, wherein the mechanism which peels the stamper has a pressure regulating system which performs evacuation in sequence from the outer periphery toward the center to thereby make the stamper or the transfer target body adhere to the stage by suction, when peeling the stamper from the transfer target body.

7. The imprint device according to claim 1, wherein when the stamper is peeled from the transfer target body, the fluid is fed into an interface between the stamper and the transfer target body so as to accelerate peeling.

8. The imprint device according to claim 1, wherein when the stamper is peeled from the transfer target body, a cooled fluid is fed at the back of either stamper or the transfer target body so as to accelerate peeling by utilizing a difference between linear expansion coefficients of the stamper and of the transfer target body.

9. The imprint device according to claim 1, wherein either the stamper or the transfer target body is fixed to a backup plate.

10. The imprint device according to claim 1, wherein either the stamper or the transfer target body is fixed to a backup plate with a stress buffer layer lying in between.

11. The imprint device according to claim 9, wherein the backup plate has a portion in which a groove is formed to make either the stamper or the transfer target body adhere thereto by vacuum suction.

12. The imprint device according to claim 1, wherein either the stamper or the transfer target body is fixed to a backup plate, and a thickness of the backup plate is greater than a thickness of the stamper or the transfer target body tightly fixed to the backup plate.

13. The imprint device according to claim 1, wherein a spherical seat and a spherical seat rest are provided at the back of the stage in order to bring the stamper and the transfer target body into parallelism with each other before pressing the stamper and the transfer target body.

14. The imprint device according to claim 1, comprising a movement mechanism which allows the stage to move in an in-plane direction relative to a transfer surface in order to provide relative alignment of the stamper and the transfer target body.

15. The imprint device according to claim 1, wherein an elastic disc guide is provided at the back of the stage in order to accomplish vertical movement of the stage relative to a transfer surface.

16. The imprint device according to claim 15, wherein a pressure vessel chamber is provided at the back of the stage, and the pressure vessel chamber is pressurized to accomplish vertical movement of the stage relative to the transfer surface.

17. The imprint device according to claim 16, comprising a position detector which detects a vertical position of the stage relative to the transfer surface,
wherein pressure in the pressure vessel chamber is controlled based on the measured values obtained by the position detector.

18. An imprint device which pressurizes a stamper having minute recesses and protrusions and a transfer target body, and thereby transfers recessed and protruding configurations of the stamper to a surface of the transfer target body, the device comprising:
a pressurization mechanism which ejects a fluid onto a rear surface of at least either the stamper or the transfer target body, thereby applying pressure to the rear surface of at least either the stamper or the transfer target body,
wherein during the application of the pressure, the rear surface is not in contact with other components and there is a predetermined in-plane pressure distribution.

19. A microstructure transfer method which presses a stamper having minute recesses and protrusions against a transfer target body, and thereby transfers recessed and protruding configurations of the stamper to a surface of the transfer target body, and peels the stamper, the method comprising:
the step of ejecting a fluid through a plurality of holes formed in a stage disposed at the back of at least either the stamper or the transfer target body, thereby applying pressure to the stamper and the transfer target body.

20. The microstructure transfer method according to claim 19, wherein the recesses and protrusions formed in and on the surface of the transfer target body are made of a photo-setting resin.
